(19) United States
(12) Patent Application Publication
(10) Pub. No.: US 2024/0373895 A1
(43) Pub. Date: Nov. 14, 2024

(54) ACV SUPPLEMENT FORMULATION AND METHOD OF PRODUCING

(71) Applicant: Bragg Live Food Products, LLC, Santa Barbara, CA (US)

(72) Inventors: Louis Izuchukwu Ndife, Columbus, OH (US); Jones Yiu Chung Chan, Foster City, CA (US); Jose Emilio Villarreal, Seaside, CA (US); Diane Humphrey Kull, New Market, VA (US)

(21) Appl. No.: 18/542,529

(22) Filed: Dec. 15, 2023

Related U.S. Application Data
(60) Provisional application No. 63/500,845, filed on May 8, 2023.

(51) Int. Cl. A23L 33/105; A23L 29/00; A23L 33/155

(52) U.S. Cl. CPC A23L 33/105; A23L 29/015; A23L 29/03; A23L 33/155

(57) ABSTRACT

There is disclosed a novel method for introducing non-GMO acetate to the human body.

### RELATED APPLICATION INFORMATION

The present application claims priority to U.S. Provisional Application No. 63/500,845 filed May 8, 2023 entitled “ACV SUPPLEMENT FORMULATION AND METHOD OF PRODUCING” of which is incorporated herein by reference in its entirety.

### NOTICE OF COPYRIGHTS AND TRADE DRESS

A portion of the disclosure of this patent document contains material which is subject to copyright protection. This patent document may show and/or describe matter which is or may become trade dress of the owner. The copyright and trade dress owner has no objection to the facsimile reproduction by anyone of the patent disclosure as it appears in the Patent and Trademark Office patent files or records, but otherwise reserves all copyright and trade dress rights whatsoever.

### BACKGROUND

### Field

The invention is a supplement formulation containing vinegar and salts of acetic acid in various supplement delivery forms to deliver a meaningful amount of acetic acid to support health benefits such as healthy blood glucose, cholesterol, and weight levels.

### Description of the Related Art

In ancient times, apple cider vinegar (ACV) was utilized for a variety of purposes across different cultures. In ancient Egypt, around 3000 BCE, vinegar was used for both culinary and medicinal purposes. The Babylonians, around 5000 BCE, reportedly used vinegar as a preservative and condiment. In ancient Greece, Hippocrates, prescribed a mixture of honey and vinegar for various ailments. The Romans produced vinegar by fermenting wine, and it was a common condiment in their food. In Asia, especially in China, vinegar was used for culinary purposes and as a preservative. ACV's acidity made it useful in food preservation, and it was also believed to have health benefits, ranging from digestion aid to wound disinfection.

In the early 1900s, apple cider vinegar became a popular household staple with a rich history of different uses. ACV's reputation as a natural remedy persisted, with many households incorporating it into traditional health remedies. ACV was often employed for its purported benefits in digestion, acting as a tonic to alleviate indigestion and promote gut health. Furthermore, its acidic properties made it a sought-after ingredient for preserving and pickling fruits and vegetables in the absence of modern refrigeration methods. Beyond culinary applications, apple cider vinegar found a place in beauty routines, as it was believed to enhance the skin and hair's natural shine. This era marked a continuation of ACV's longstanding presence in homes, embodying a multi-faceted role as a culinary, medicinal, and cosmetic resource.

Prevailing science indicates consuming one or more tablespoons of vinegar such as apple cider vinegar provides health benefits. The active component of vinegar is acetic acid. Clinical dose has been shown to be as low as 500 mg of acetic acid. Barriers to consuming efficacious amount of vinegar are taste and enamel corrosion. The concentration of acetic acid in vinegar in either powder or liquid form is insufficient to deliver efficacious dosing in a supplement form without causing compliance issues. There are no supplements in the marketplace that provide efficacious dosing of acetic acid.

Health benefits of Apple Cider Vinegar (ACV) drinks have been reported widely in scientific literature. Some of the benefits include providing support for healthy blood glucose level, healthy blood lipid profile and, healthy body weight maintenance (Ostman et al. 2005³, Carol S. Johnston et al., 2010a (trial 1)⁴ Tomoo Kondo et. al., 2009¹. Carmelo Panetta et al., 2013², Darzi et al., 2014⁵). It is also known that the active component of ACV that is responsible for most of these health benefits is the acetic acid. Acetic acid is produced in the process of manufacturing ACV by the action of acetic acid bacteria that are inherent in the apple or its unpasteurized juice. ACV dosage is generally given to be 1-2 table spoonful (TBSP) per day to be consumed with a meal and plenty of water. Since a TBSP is about 15 mL and with a total acetic acid content of about 5% and a density of about 1.0, a TBSP contains 15 g ACV liquid or 750 mg acetic acid. Some of the human clinical studies listed above have shown that intake of 750 mg acetic acid per day would support those health benefits both in healthy and unhealthy individuals. Recent advents in analytical chemistry and double blind clinical studies have allowed modern researchers to not only pinpoint the exact cause of apple cider vinegar's health benefits, but also formulate modern day remedies that allow for users to obtain the health benefits of ACV without the negative taste.

### DESCRIPTION OF THE DRAWINGS

FIG. 1 is a drawing of a chemical structure of acetic acid.

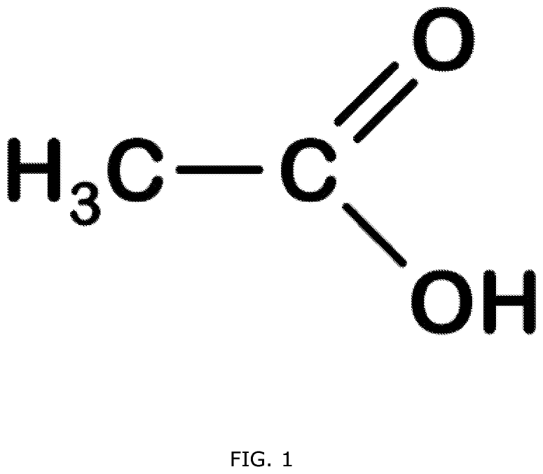

FIG. 2 is a drawing of a chemical synthesis of vinegar from apples.

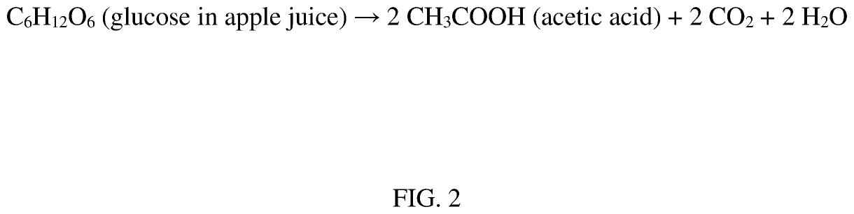

### DETAILED DESCRIPTION

The present disclosure describes multiple embodiments for producing and using solid dose Apple Cider Vinegar (ACV) either as a dry powder, a blend of ACV powder and/or an appropriate salt of acetic acid in a capsule form to deliver an efficacious amount of acetic acid of 500 mg to 2000 mg acetic acid, more preferably 500 mg to 1250 mg and most preferably, 500 to 800 mg per dose of 2 to 8 capsules, more preferably, 2 to 5 capsules and most preferably, 2 to 4 capsules.

Sodium diacetate is a chemical compound with the molecular formula of C₄H₇NaO₄. It is a white crystalline powder that is highly soluble in water and has a melting point of 324° C. Sodium diacetate is a mixture of approximately 50:50 mixture of acetic acid and sodium acetate (the sodium salt of acetic acid). When dissolved in water, sodium diacetate disassociates into acetic acid and sodium acetate ions. Acetic acid is a weak organic carboxylic acid that can exist in water as the acid (protonated) form or as a salt (deprotonated) form depending on the pH of the medium. At pH 1-3, it is mainly in the carboxylic acid form, acetic acid can be protonated or de-protonated forms depending on pH of the medium. Whereas, at neutral pH of 7, it is mainly in the salt form, sodium acetate. Acetic acid is the main nutrient found in vinegar and is credited for many of the health benefits associated with vinegar consumption.

In one embodiment dry ACV powder can be achieved by tower spray-drying ACV liquid slurry or by vacuum-assisted freeze-drying of ACV in the presence of an appropriate cryoprotectant. Blending ACV powder with salts of acetate, however, is a better option for operational, cost of manufacture, and health reasons. In another embodiment salts of acetic acid used can include sodium acetate, potassium acetate, sodium di-acetate, potassium di-acetate, acetate, iron acetate, magnesium acetate. The ability to remain in a dry state at room temperature, ease of handling by plant operators and the capability to deliver adequate amounts of acetate molecules per gram of ingredient make sodium di-acetate and potassium di-acetate better preferred with sodium di-acetate being the most preferred acetic acid salt in the present disclosure. Consuming 750 mg acetic acid from Liquid ACV is generally known for its repulsive sour taste. 750 mg dosing if put in the correct delivery form can alleviate the sour taste. Mixture formulation of vinegar (liquid or powder) and salts of acetic acid: Vinegar—0.0%, Salts of AA—100.0% Preferably Vinegar 0.1%, Salts of AA—99.9% Most preferably Vinegar 50.1%, Salts of AA 49.9%.

Potential supplement forms to provide 750 mg acetic acid dosing forms include tablet (chewable, swallowable, fast melt), gummy (chewable, suckers), 2 piece capsule and softgels. The chewables and suckers cannot solve the sour flavor of acetic acid especially if one must control the amount of sugar per dose. Of the swallowable, 2 piece capsules and softgels are not only easier to consume but are better preferred than tablets by consumers. Additionally, powder sachet as a drink mix may also be used. Furthermore, tablets may have a greater chance of contacting taste buds on the tongue to elicit sour note sensation in some sensitive individuals. 2 piece capsule or softgel delivery forms therefore afford best protection from the sour taste of acetic acid. They are easier to swallow and, are sugar-free. Additionally, acetic acid is assayed using HPLC as titratable acid test is not specific enough as it picks up other organic acids.

Studies have revealed that consumers are sensitive to the number of capsules they must take to have efficacious levels of bioactive in their systems. This is understandable given that some of these consumers are already taking other solid dose medications throughout the day. The present disclosure therefore requires 2 to 8 capsules per dose. more preferably 3 to 6 capsules and most preferably, 3 to 4 capsules.

The following table lists several examples of a 3 capsule regimen:

TABLE 1

| | |
|---|---|
| Core Ingredient | 1677 mg of Bragg proprietary blend in |
| | approximately 1 to 1 ratio of sodium di-acetate |
| | (847 mg) and dry ACV powder (830 mg). |
| Discretionary Ingredients | Excipients as required and necessary. |

TABLE 2

| | |
|---|---|
| Core Ingredients | 1677 mg of Bragg proprietary blend in |
| | approximately 1 to 1 ratio of sodium di-acetate |
| | (847 mg) and dry ACV powder (830 mg). |
| | Excipients as required and necessary. |
| Discretionary Ingredients | Thiamine, Riboflavin, Niacin, Biotin, |
| | Pantothenic acid, Pyridoxine, Vitamin B12, |
| | Folic Acid, Vitamin C, Vitamin D, Vitamin E, |
| | Vitamin K, Calcium, Potassium, Phosphorus, |
| | Sodium, Magnesium, Iron, Zinc, Copper, |
| | Selenium, Molybdenum, Iodine. |

TABLE 3

| | |
|---|---|
| Core Ingredients | 1677 mg of Bragg proprietary blend in |
| | approximately 1 to 1 ratio of sodium di-acetate |
| | (847 mg) and dry ACV powder (830 mg). |
| | Excipients as required and necessary |
| Discretionary Ingredients | Thiamine, Riboflavin, Niacin, Pantothenic |
| | acid, Biotin, Vitamin B12 |

TABLE 4

| | |
|---|---|
| Core Ingredients | 1677 mg of Bragg proprietary blend in |
| | approximately 1 to 1 ratio of sodium di-acetate |
| | (847 mg) and dry ACV powder (830 mg). |
| | Excipients as required and necessary |
| Discretionary Ingredients | Vitamin D3, Zinc. |

TABLE 5

| | |
|---|---|
| Core Ingredients | 1677 mg of Bragg proprietary blend in |
| | approximately 1 to 1 ratio of sodium di-acetate |
| | (847 mg) and dry ACV powder (830 mg). |
| | Excipients as required and necessary |
| Discretionary Ingredients | Thiamine, Riboflavin, Niacin, Pantothenic |
| | acid, Vitamin B12 |

TABLE 6

| | |
|---|---|
| Core Ingredients | 1677 mg of Bragg proprietary blend in |
| | approximately 1 to 1 ratio of sodium di-acetate |
| | (847 mg) and dry ACV powder (830 mg). |
| | Excipients as required and necessary |
| Discretionary Ingredients | Organic Ashwagandha extract. |

Additionally, for formulations generated from the table above it should be understood that 1877 mg of proprietary blend may be used instead of 1677. This is because the acetate and ACV powder may be adjusted accordingly for all the examples. Finally, nutrients such as vitamins, minerals, herbs, functional oils, amino acids and other specialty supplement actives may be combined with the proprietary blend listed above.

A potential version of the invention includes a nutritional supplement comprising a powder formulation of dry ACV and an acetate salt configured to deliver at least 500 mg of acetic acid per dose per day. Another version of the invention could include the powder formulation of a nutritional supplement comprising a powder formulation of dry ACV and an acetate salt wherein the powder also includes, Organic Apple Cider Vinegar Powder 3-8% Acetic Acid (313 mg—940 mg); Sodium Diacetate food grade crystal (250 mg-750 mg); Vitamin D3 Cholecalicferol 100,000 iu (0.01 mg-0.03 mg); Zinc Oxide (80% ZN) powder (4.3 mg-13 mg); Silicon Dioxide powder (3.2 mg-9.6 mg); Pea Starch powder (24.4 mg-73.3 mg).

It should be understood that the acetate salts listed above could include acetate salt, sodium, di-sodium, di-potassium. Additionally, another version of the invention could include wherein nutritional supplement comes in the form of a solid two piece hard shell or softgel capsule. A method for delivering is also disclosed herein. One potential method could include a method of delivering 500 mg of acetic acid to a person in need thereof comprising: ingesting a nutritional supplement comprising a powder formulation of dry ACV and an acetate salt. The method above could be further narrowed by delivering the dose in 2 to 8 capsules a day. The method above could be further narrowed nutrients including the 23 major vitamins and minerals or a subset of them.

### Closing Comments

Throughout this description, the embodiments and examples shown should be considered as examples, rather than limitations on the apparatus and procedures disclosed or claimed. Although many of the examples presented herein involve specific combinations of method acts or system elements, it should be understood that those acts and those elements may be combined in other ways to accomplish the same objectives. With regard to flowcharts, additional and fewer steps may be taken, and the steps as shown may be combined or further refined to achieve the methods described herein. Acts, elements and features discussed only in connection with one embodiment are not intended to be excluded from a similar role in other embodiments.

As used herein, “plurality” means two or more. As used herein, a “set” of items may include one or more of such items. As used herein, whether in the written description or the claims, the terms “comprising”, “including”, “carrying”, “having”, “containing”, “involving”, and the like are to be understood to be open-ended, i.e., to mean including but not limited to. Only the transitional phrases “consisting of” and “consisting essentially of”, respectively, are closed or semi-closed transitional phrases with respect to claims. Use of ordinal terms such as “first”, “second”, “third”, etc., in the claims to modify a claim element does not by itself connote any priority, precedence, or order of one claim element over another or the temporal order in which acts of a method are performed, but are used merely as labels to distinguish one claim element having a certain name from another element having a same name (but for use of the ordinal term) to distinguish the claim elements. As used herein, “and/or” means that the listed items are alternatives, but the alternatives also include any combination of the listed items.

It is claimed:

1. A nutritional supplement comprising a powder formulation of dry ACV and an acetate salt configured to deliver at least 500 mg of acetic acid per dose per day.

2. The powder formulation of ACV of claim 1 wherein the powder comprises:
Organic Apple Cider Vinegar Powder 3-8% Acetic Acid (313 mg-940 mg)
Sodium Diacetate food grade crystal (250 mg-750 mg);
Vitamin D3 Cholecalicferol 100,000 iu (0.01 mg-0.03 mg);
Zinc Oxide (80% ZN) powder (4.3 mg-13 mg);
Silicon Dioxide powder (3.2 mg-9.6 mg);
Pea Starch powder (24.4 mg-73.3 mg).

3. The nutritional supplement of claim 1 wherein the acetate salt comprises sodium.

4. The nutritional supplement of claim 1 wherein the acetate salt comprises potassium.

5. The nutritional supplement of claim 1 wherein the acetate salt comprises di-sodium.

6. The nutritional supplement of claim 1 wherein the acetate salt comprises di-potassium.

7. The nutritional supplement of claim 1 wherein nutritional supplement comes in the form of a solid two piece hard shell or softgel capsule.

8. A method of delivering 500 mg of acetic acid to a person in need thereof comprising:
ingesting a nutritional supplement comprising a powder formulation of dry ACV and an acetate salt.

9. The method of claim 8 wherein the nutritional supplement further comprises 2 to 8 capsules a day.

10. The method of claim 8 wherein the nutritional supplement may contain other nutrients including the 23 major vitamins and minerals or a subset of them.
